(19) United States
(12) Patent Application Publication
(10) Pub. No.: US 2023/0004696 A1
(43) Pub. Date: Jan. 5, 2023

(54) MICROSCOPE SIMULATION DEVICE, METHOD, AND COMPUTER READABLE MEDIUM

(71) Applicant: EVIDENT CORPORATION, Nagano (JP)

(72) Inventors: Shodai HOSONO, Tokyo (JP); Hideaki ENDO, Tokyo (JP)

(73) Assignee: EVIDENT CORPORATION, Nagano (JP)

(21) Appl. No.: 17/851,597

(22) Filed: Jun. 28, 2022

(30) Foreign Application Priority Data
Jul. 2, 2021 (JP) 2021-111023

(51) Int. Cl. G06F 30/23; G02B 21/36; G06F 30/12

(52) U.S. Cl. CPC G06F 30/23; G02B 21/368; G06F 30/12; G06F 2111/20

(57) ABSTRACT

A microscope simulation device includes a processor. The processor is configured to acquire a plurality of pieces of component information each indicating a technical specification of a corresponding microscope component, simulate an assembly of a microscope system based on the acquired plurality of pieces of component information, and output a generated simulation result to a display device.

### TECHNICAL FIELD

This application is based upon and claims the benefit of priority from prior Japanese Patent Application No. 2021-111023, filed Jul. 2, 2021, the entire contents of which are incorporated herein by this reference.

### TECHNICAL FIELD

The disclosure of the present specification relates to a microscope simulation device, a method, and a computer-readable medium.

### BACKGROUND

Currently, many microscope systems employ a modular design. By appropriately combining the modularized components, it is possible to provide an optimal microscope system according to the use and demand of users.

On the other hand, it is not always easy to understand the effectiveness of a combination of components. A technique related to such a technical problem is described in, for example, JP 2013-231861 A.

### SUMMARY

A microscope simulation device according to an aspect of the present invention includes a processor, in which the processor is further configured to perform acquiring a plurality of pieces of component information each indicating a technical specification of a corresponding microscope component, simulating an assembly of a microscope system based on the plurality of pieces of acquired component information, and outputting a generated simulation result to a display device.

A method according to an aspect of the present invention is a computer-implemented method including acquiring a plurality of pieces of component information each indicating a technical of a corresponding microscope component, simulating an assembly of a microscope system based on the plurality of pieces of component information, and outputting a simulation result of the assembly of the microscope system to a display device.

A non-transitory computer readable medium according to an aspect of the present invention is a non-transitory computer-readable medium that stores a program for causing a computer to execute processes of acquiring a plurality of pieces of component information each indicating a technical of a corresponding microscope component, simulating an assembly of a microscope system based on the plurality of pieces of component information, and outputting a simulation result of the assembly of the microscope system to a display device.

### BRIEF DESCRIPTION OF DRAWINGS

The present invention will be more apparent from the following detailed description when the accompanying drawings are referenced.

FIG. 1 is a diagram illustrating an example of a configuration of a system;

FIG. 2 is a diagram illustrating an example of a functional configuration of a server device;

FIG. 3 is a diagram for describing an example of a method of specifying requirements to be satisfied by a microscope system;

FIG. 4 is a diagram for describing an example of a method of selecting a combination of microscope components;

FIG. 5 is a view illustrating an example of a simulation result;

FIG. 6 is an example of a flowchart of a process performed by a server device;

FIG. 7 is a diagram illustrating an example of component information on an observation method;

FIG. 8 is a diagram illustrating an example of component information on dimensions;

FIG. 9 is a diagram illustrating an example of component information on a weight;

FIG. 10 is an example of a flowchart of a simulation process;

FIG. 11 illustrates an example of connection master information covering connectivity between the microscope components;

FIG. 12 is a diagram illustrating another example of the simulation result;

FIG. 13 is a diagram illustrating still another example of the simulation result;

FIG. 14 is a diagram illustrating an example of template information indicating a recommended combination;

FIG. 15 is a diagram illustrating still another example of the simulation result;

FIG. 16 is a diagram illustrating still another example of the simulation result;

FIG. 17 is a diagram for describing another example of a method of selecting a combination of the microscope components;

FIG. 18 is diagram illustrating an example of a hardware configuration of a computer to implement the server device; and

FIG. 19 is another example of a flowchart of a process performed by the server device.

### DESCRIPTION OF EMBODIMENTS

Incidentally, in the technology described in JP 2013 -231861 A, in order to confirm the effectiveness of a certain combination, it is necessary to assemble a microscope system by actually combining components.

Considering such circumstances, an embodiment of the present invention will be described hereinafter.

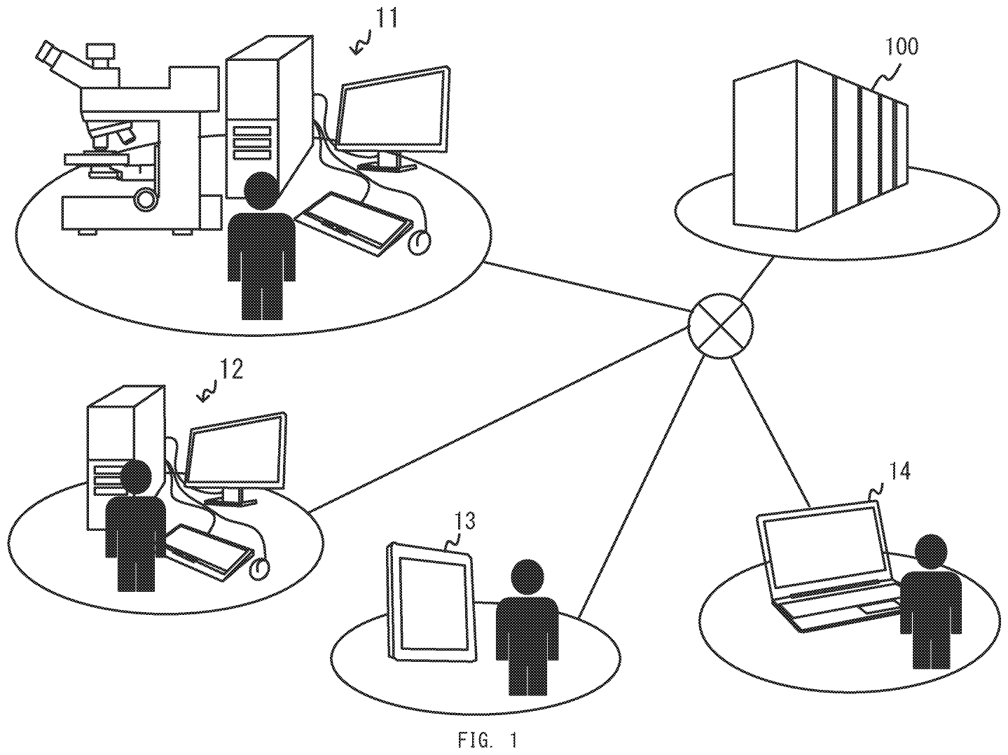

FIG. 1 is a diagram illustrating an example of a configuration of a system. First, the configuration of the system shown in FIG. 1 will be described with reference to FIG. 1. As illustrated in FIG. 1, the system includes a server device 100 and one or more client devices (a client device 11, a client device 12, a client device 13, and a client device 14) connected to each other via a network.

The type of the network is not particularly limited. For example, the network may be a public network such as the Internet, a dedicated network, or a local area network (LAN). The connection between the server device 100 and the client device may be a wired connection or a wireless connection.

The server device 100 is a microscope simulation device that simulates the assembly of the microscope system. The server device 100 includes at least an electric circuit, and the electric circuit executes various processes to perform simulation that will be described later. The electric circuit is not particularly limited, but may include, for example, a processor such as a CPU and a memory. The server device 100 virtually performs assembly on a computer without assembling the microscope system by actually combining the microscope components (that is, performs simulation).

The server device 100 may further include a storage device that stores various types of master data (component information, connection master information, and template information to be described later) used for simulation. However, the master data may be stored in a device different from the server device 100 that executes the simulation, and the server device 100 may acquire the master data from the different device as necessary.

The client device is a device used by a user of the system to access the server device 100. Hereinafter, the client devices (the client device 11, the client device 12, the client device 13, and the client device 14) included in the system illustrated in FIG. 1 are collectively referred to as a client device 10. However, in a case where these client devices are not particularly distinguished, each client device is also referred to as the client device 10.

The client device 10 only needs to include at least an input device and a display device, and desirably further includes a communication device. The client device 10 receives inputs of various conditions for simulation from the user, and provides a result of the simulation executed by the server device 100 to the user by displaying the result.

For example, the client device 11 which is an example of the client device 10 is a microscope system. The user may access the server device 100 to simulate the assembly of the microscope system using the client device 11 that is the microscope system.

In addition, the client device 10 may be, for example, a desktop computer such as the client device 12, a tablet computer such as the client device 13, or a laptop computer such as the client device 14. Further, it may be a smartphone, a cellular phone, or the like. Further, each client device 10 may be a dedicated terminal for a specific user or a shared terminal shared by multiple users.

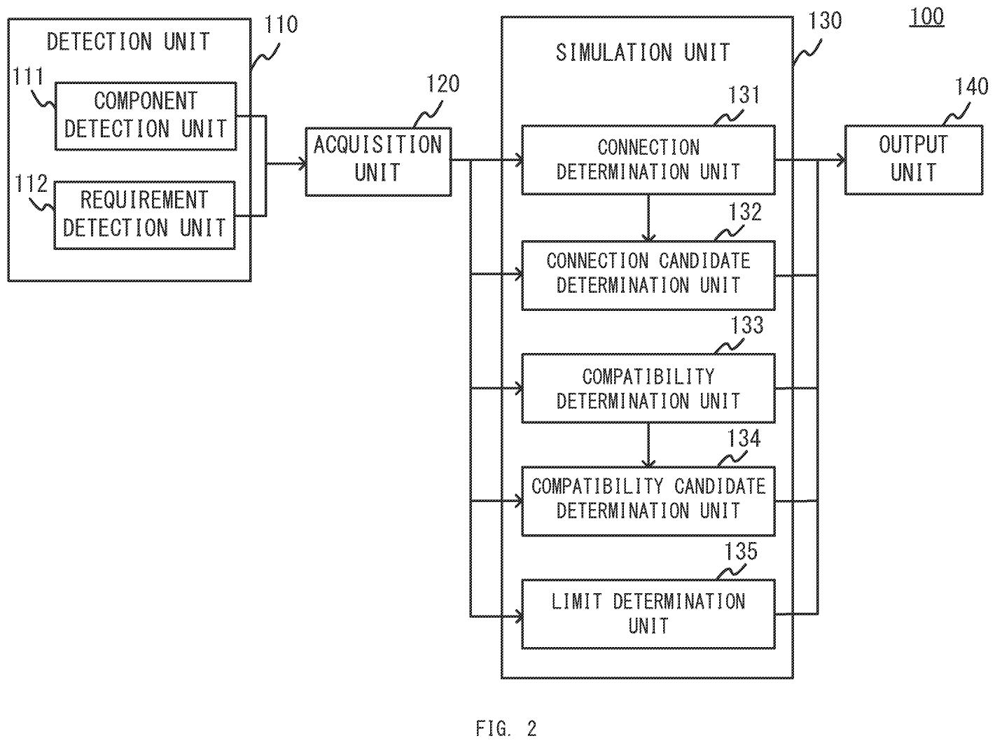

FIG. 2 is a diagram illustrating an example of a functional configuration of a server device. The server device 100 includes a detection unit 110, an acquisition unit 120, a simulation unit 130, and an output unit 140. Hereinafter, a configuration related to simulation of assembly of the microscope system will be described with reference to FIG. 2.

The detection unit 110 detects a user's operation. The detection unit 110 includes, for example, a component detection unit 111 and a requirement detection unit 112. The component detection unit 111 detects a user's operation of assigning the microscope components to a category for classifying the microscope components. The requirement detection unit 112 detects the user's operation that specifies a requirement that the microscope system should satisfy.

The acquisition unit 120 acquires a plurality of pieces of component information. Each of the plurality of pieces of component information indicates a technical specification of a corresponding microscope component. Furthermore, the plurality of microscope components corresponding to the plurality of pieces of component information may include the microscope component assigned by the user's operation detected by the component detection unit 111. That is, the acquisition unit 120 may acquire the component information of the microscope component (hereinafter, referred to as a user component) assigned to the category by the operation detected by the component detection unit 111. In addition to the plurality of pieces of component information, the acquisition unit 120 may acquire a requirement (hereinafter, referred to as a user-specified requirement) specified by the operation detected by the requirement detection unit 112.

The simulation unit 130 simulates the assembly of the microscope system based on the plurality of pieces of component information acquired by the acquisition unit 120. The simulation unit 130 includes, for example, a connection determination unit 131, a connection candidate determination unit 132, a compatibility determination unit 133, a compatibility candidate determination unit 134, and a limit determination unit 135.

The connection determination unit 131 determines whether a combination of a plurality of microscope components corresponding to a plurality of pieces of component information is successfully connected. In a case where the connectivity information that is generated by the connection determination unit 131 and indicates whether the connection of the combination of the plurality of microscope components is successful indicates failure of the connection of the combination of the plurality of microscope components, the connection candidate determination unit 132 determines a microscope component (hereinafter, referred to as a connection candidate component) to be substituted for the microscope component that causes the failure. The compatibility determination unit 133 determines the compatibility of the combination of a plurality of microscope components with a user-specified requirement. In a case where the compatibility information indicating the compatibility of the combination of the plurality of microscope components with the user-specified requirement indicates non-compatibility with the user-specified requirement, the compatibility candidate determination unit 134 determines a microscope component (hereinafter, referred to as a compatibility candidate component) to be substituted for the microscope component that causes the non-compatibility. The limit determination unit 135 determines use limitations in a combination of a plurality of microscope components.

In other words, the simulation of the assembly of the microscope system performed by the simulation unit 130 is a simulation of a combination of a plurality of microscope components. More specifically, the simulation may be a determination of the success or failure of connection of the combination of the plurality of microscope components, a determination of an alternative component (connection candidate component) of the microscope component that causes the connection failure, a determination of compatibility of the combination of the plurality of microscope components with a user-specified requirement, a determination of an alternative component (compatibility candidate component) of the microscope component that causes non-compatibility with the user-specified requirement, a determination of limitations on use in the combination of the plurality of microscope components, or the like. These determination results may be generated as simulation results.

The output unit 140 outputs the simulation results generated by the simulation unit 130 to the display device. Specifically, the output unit 140 may output the connectivity information generated by the connection determination unit 131 as at least a part of the simulation results. The output unit 140 may output the compatibility information generated by the compatibility determination unit 133 as at least a part of the simulation results. In addition, the output unit 140 may output alternative candidate information indicating the connection candidate component generated by the connection candidate determination unit 132 and the compatibility candidate component generated by the compatibility candidate determination unit 134. The output unit 140 may output the restriction information indicating the limitations in use in the combination of the plurality of microscope components generated by the limit determination unit 135. Note that the display device to which the simulation results are output is, for example, a display device of a client terminal, but may be a display device of the server device 100.

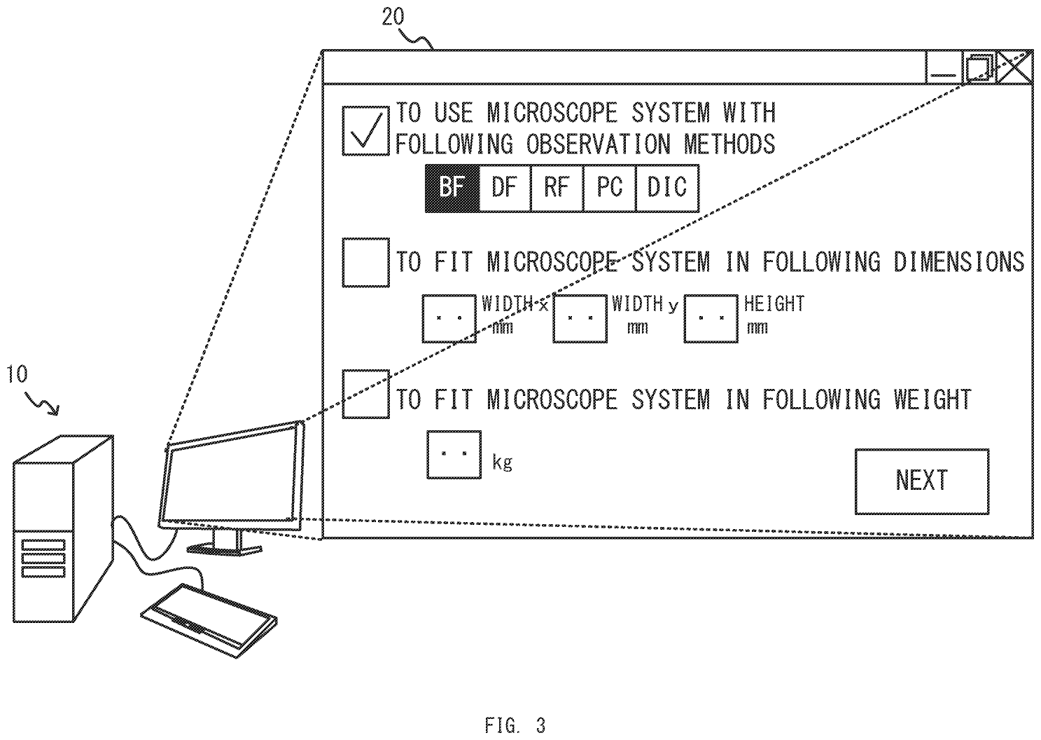

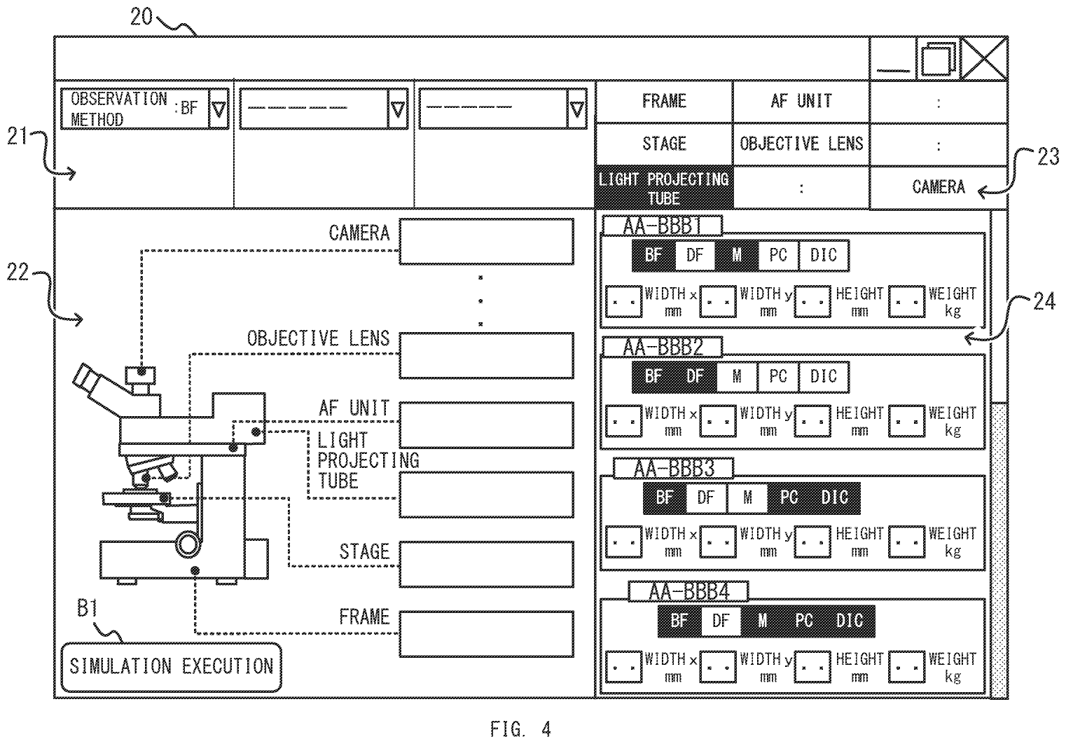

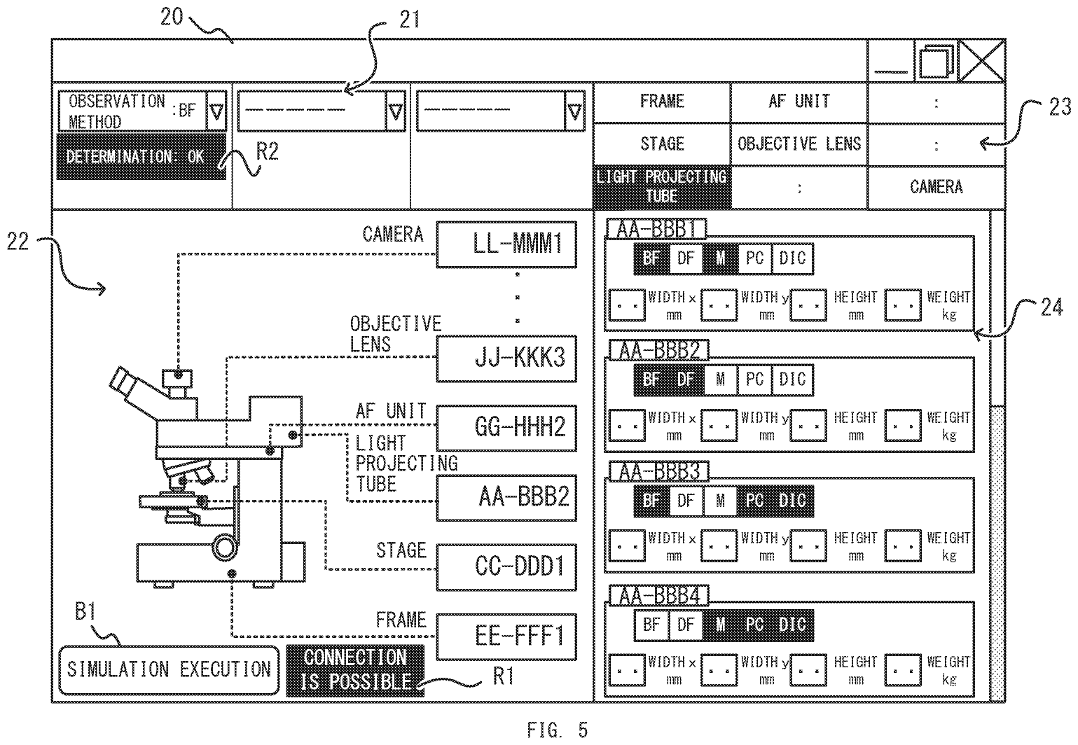

FIG. 3 is a diagram for describing an example of a method of specifying requirements to be satisfied by a microscope system. FIG. 4 is a diagram for describing an example of a method of selecting a combination of microscope components. FIG. 5 is a view illustrating an example of a simulation result. Hereinafter, with reference to FIGS. 3 to 5, an operation performed by the user to perform a simulation in the server device 100 will be described.

Hereinafter, an example in which a dedicated client application installed in the client device 10 is activated to access an application provided by the server device 100 will be described. However, the application provided by the server device 100 may be a web application, or the application of the server device 100 may be accessed using a web browser of the client device 10. In this case, it is not necessary to install a dedicated application in each client device 10, and access becomes convenient.

When the client device 10 starts the client application, a main window 20 is displayed on the display device of the client device 10 as illustrated in FIG. 3, for example. When the user specifies a requirement to be satisfied by the microscope system according to the guidance in the main window 20, the client device 10 receives the specified requirement.

FIG. 3 illustrates an example in which at least one of an observation method to be supported by the microscope system, an allowable dimension of the microscope system, and an allowable weight of the microscope system is specified as the requirements to be satisfied by the microscope system, but the requirements to be satisfied by the microscope system is not limited to these examples.

When the requirement is specified, for example, the main window 20 illustrated in FIG. 4 is displayed on the display device of the client device 10. In an area 21, a requirement specified by the user (the user-specified requirement) is displayed. Here, an example in which a requirement that the microscope system supports a bright field observation method (BF) is specified is illustrated. Note that the user may reset or additionally set the user-specified requirement by operating the UI control in the area 21.

In an area 22, a combination of microscope components to be simulated is displayed. FIG. 4 illustrates a state where no microscope component is specified at all. A combination template stored in advance may be displayed in the area 22 by default. An area 23 is an area for selecting a category of microscope components, and a list of microscope components of the category selected in the area 23 is displayed in the area 24. FIG. 4 illustrates a state where the category “light projecting tube” is selected in the area 23 and the light projecting tube units are displayed in a list in an area 24.

The user can specify the microscope component to be simulated by moving any component among the microscope components displayed in the area 24 to the area 22, for example, by dragging and dropping. A method of specifying the target microscope component is not particularly limited. For example, an icon may be double-clicked or a radio button (not illustrated) may be selected. In addition, the microscope components displayed in the list are not limited to text information, and may be displayed as image information, for example, a 3D model. In particular, when the microscope component is displayed as image information, the user can visually determine the microscope component without relying on text information, and can easily select the microscope component. In addition, a search box may be provided in the area 24, and a desired microscope component may be specified by inputting a model number or the like in the search box.

When an execution button B1 is pressed, the virtual assembly of the microscope system, that is, the simulation of the assembly of the microscope system, is performed by the server device 100 by virtually combining the microscope components displayed in the area 22. As a result, for example, as illustrated in FIG. 5, a simulation result R1 and a simulation result R2 are displayed on the display device of the client device 10.

The simulation result R1 is connectivity information indicating the success or failure of connection of the combination of the microscope components displayed in the area 22. The connectivity information is information indicating whether the microscope components can be connected normally, and may indicate, for example, whether the interfaces of the microscope components correspond to each other. Although FIG. 5 illustrates a state where each component can be connected normally, if any of the components cannot be connected, “connection impossible” or the like may be displayed. At that time, the components that component cannot be connected to each other may be specifically displayed as one piece of connectivity information. For example, in a case where a specific objective lens and a specific light projecting tube cannot be connected due to a difference in interface, the components that cause the connection failure may be specifically displayed, as in “this objective lens cannot be connected to this light projecting tube.” As a result, when the connection becomes impossible, it is possible to easily understand which component should be changed.

The simulation result R2 is compatibility information indicating compatibility of the combination of the microscope components displayed in the area 22 with the user-specified requirement. The compatibility information varies depending on the user-specified requirement, but may be binary information of compatibility (OK) or non-compatibility (NG), or numerical information indicating a degree of compatibility or rank information (for example, rank S, rank A, rank B, and the like). The numerical information indicating the degree of compatibility may be numerical information directly indicating the degree of compatibility (100%, 80%, or the like), or may be numerical information indirectly indicating the degree of compatibility (for example, the total weight of the microscope system under the condition that the target weight (allowable weight) is determined). The numerical information indicating the degree of compatibility may be indicated by a numerical value, or may be graphically displayed in the form of a circular graph or the like in which the degree of the compatibility can be more intuitively understood.

FIG. 5 illustrates an example in which a positive simulation result is displayed for both the connectivity information and the compatibility information. However, since the connectivity information and the compatibility information are independent of each other, a positive simulation result may be displayed for one of the connectivity information and the compatibility information and a negative simulation result may be displayed for the other. In addition, a negative simulation result may be displayed for both the connectivity information and the compatibility information. In a case where a negative simulation result is displayed regarding the connectivity information or the compatibility information, one or more proposals as to which component should be specifically changed may be displayed.

In addition, FIG. 5 illustrates an example in which microscope components of all categories are specified, but it is not always necessary to specify microscope components of all categories in order to execute simulation. For a category that is not specified, the simulation may be performed as if there were no microscope component of that category, or the simulation may be performed as if there were a predetermined standard microscope component (for example, the microscope component included in the combination template described above). Such setting of the simulation condition may be performed on a setting page (not illustrated).

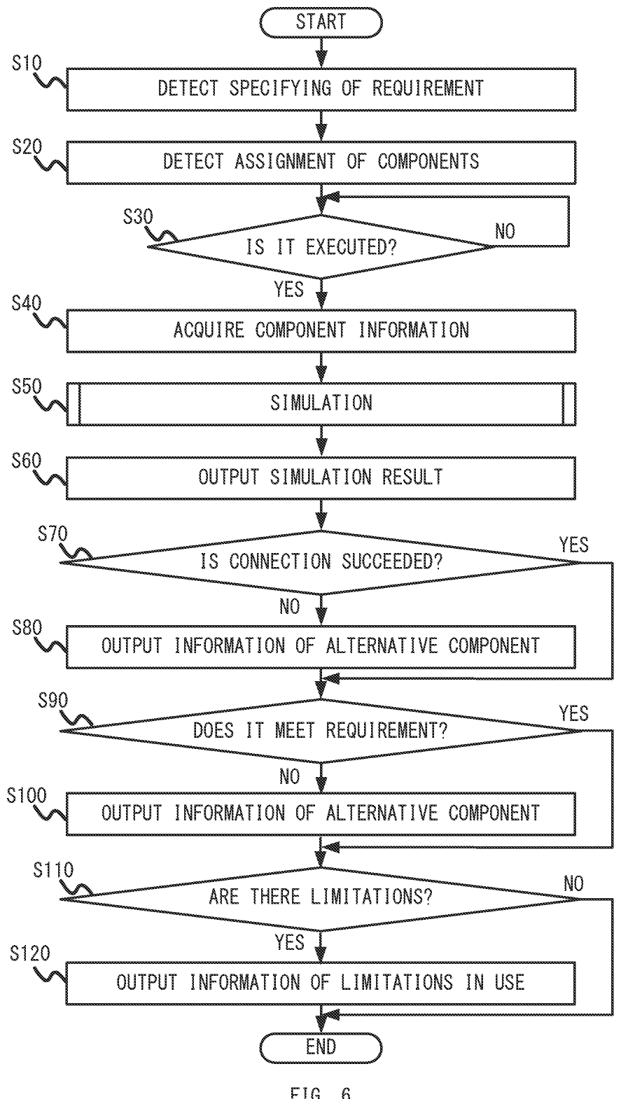

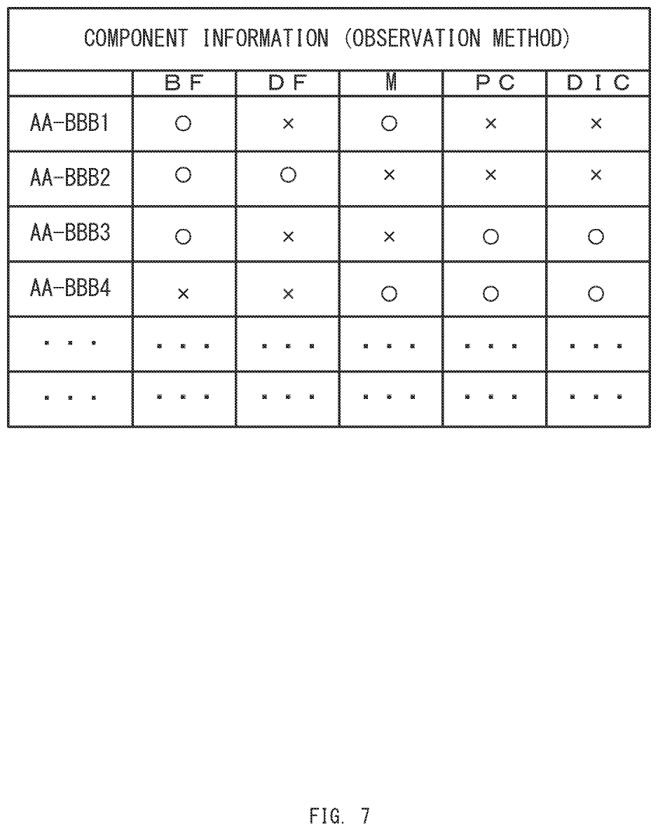

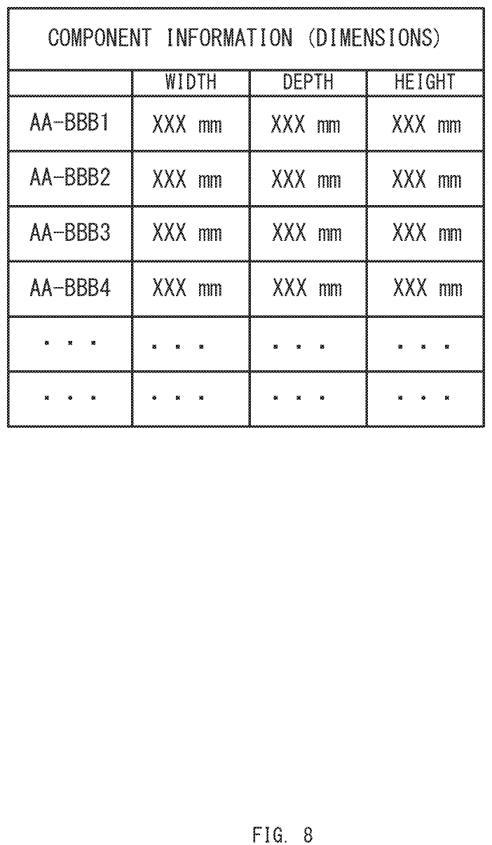

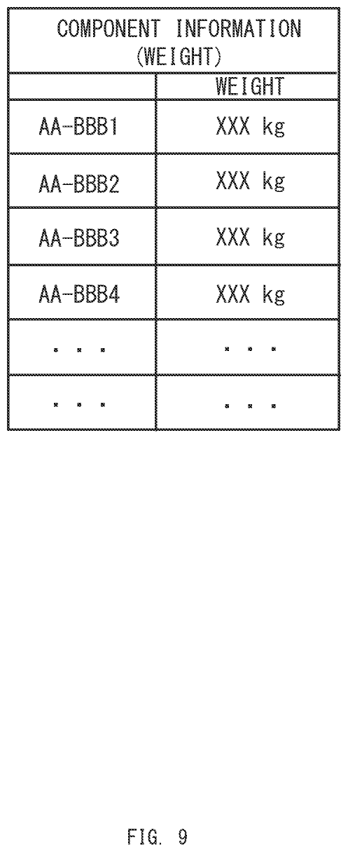

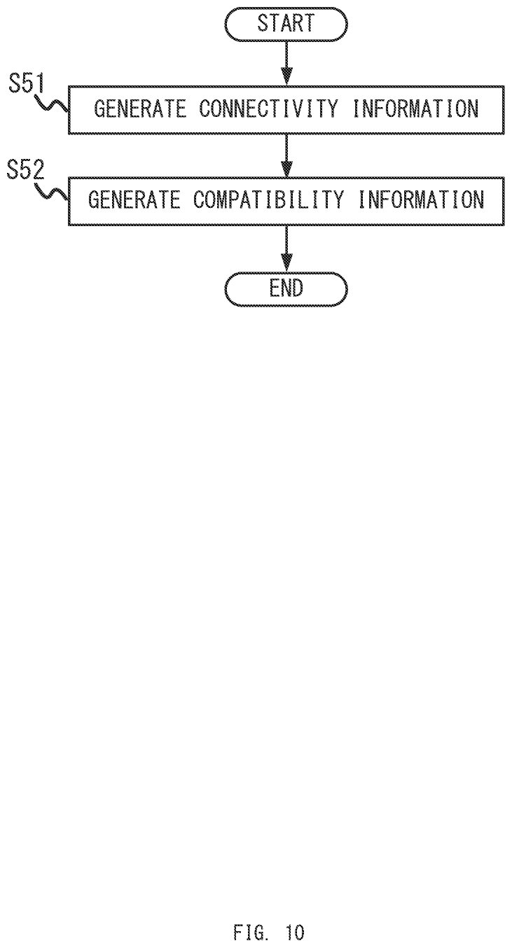

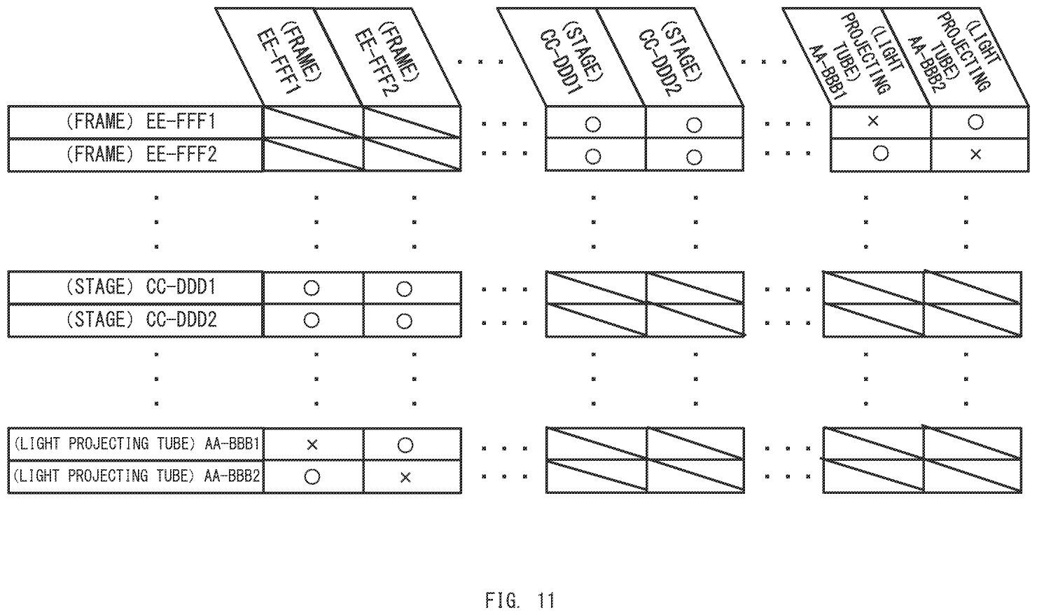

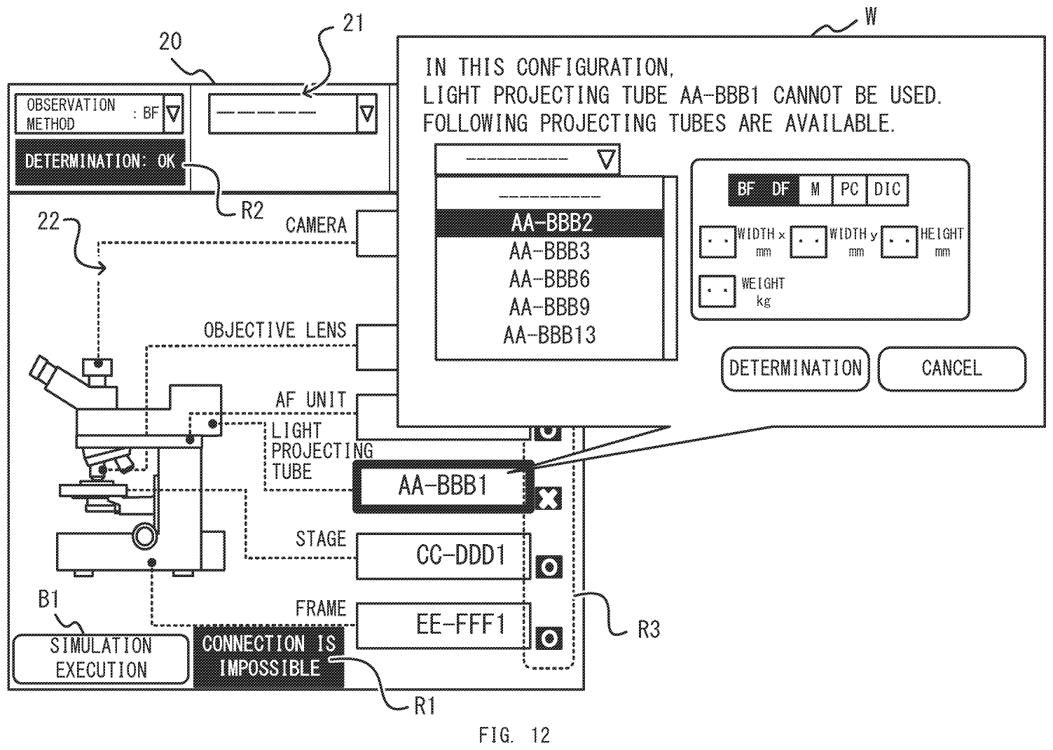

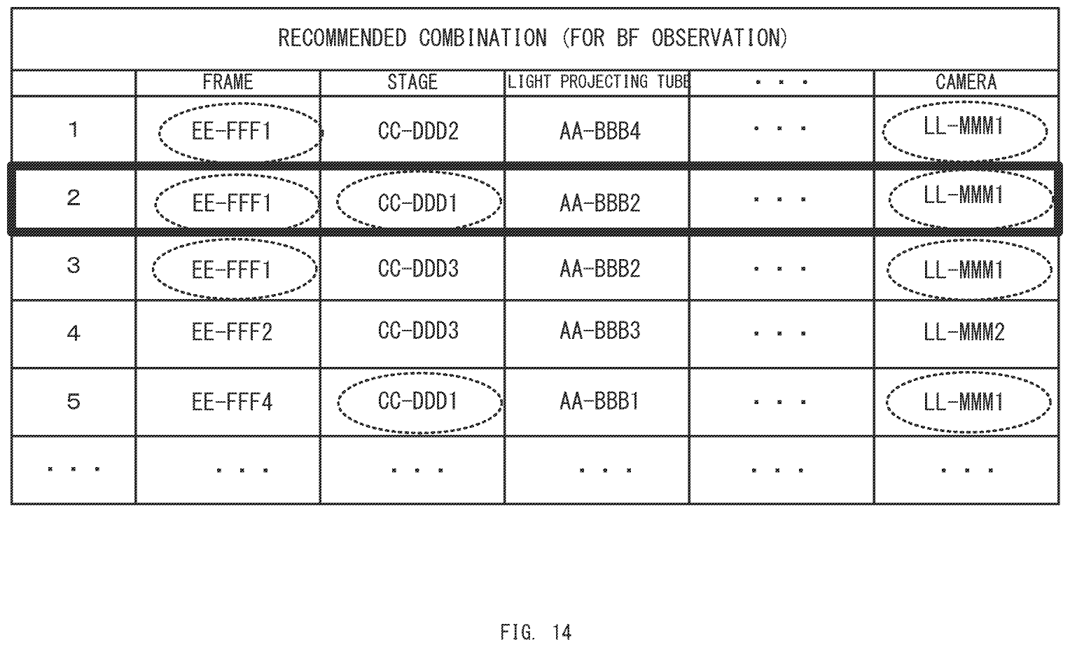

FIG. 6 is an example of a flowchart of a process performed by a server device. FIG. 7 is a diagram illustrating an example of component information on an observation method. FIG. 8 is a diagram illustrating an example of component information on dimensions. FIG. 9 is a diagram illustrating component information on a weight. FIG. 10 is an example of a flowchart of a simulation process. FIG. 11 illustrates an example of connection master information covering connectivity between the microscope components. Each of FIGS. 12, 13, 15, and 16 is a diagram illustrating an example of a simulation result. FIG. 14 is a diagram illustrating an example of template information indicating a recommended combination. Below, with reference to FIGS. 6 to 16, processes performed by the server device 100 will be specifically described.

When the processor of the server device 100 executes the program, the process illustrated in FIG. 6 is performed. First, the server device 100 detects specification of a requirement (step S10), and further detects assignment of the microscope components (step S20).

In step S10, as illustrated in FIG. 3, the user specifies the requirement to be satisfied by the microscope system in the client device 10, so that the processor of the server device 100 detects the user's operation and detects the user-specified requirement. The user-specified requirement may be, for example, a specification of an observation method which the microscope system supports, an allowable dimension of the microscope system, or an allowable weight of the microscope system.

In step S20, the user selects any microscope component from the list displayed in the area 24 so that the processor detects the user's operation and detects the assignment of that microscope component to the category selected in the area 23. Further, as the user selects microscope components of the plurality of categories, the processor detects an assignment of the microscope components to the plurality of categories. Note that the microscope component assigned to the category by the user is referred to as a user component.

Upon determining that the execution button B 1 has been pressed (step S30: YES), the processor acquires the component information of the microscope component (step S40). In step S40, component information of a plurality of microscope components corresponding to a combination of microscope components to be simulated is acquired. Specifically, the component information of the user component assigned to the category in step S20 is acquired.

The component information of the microscope component is stored in advance in the storage device of the server device 100, for example. The processor acquires the component information of the user component by reading the component information from the storage device.

The component information is information indicating technical specifications of the microscope component. The technical specifications may include physical specifications, optical specifications, chemical specifications, and the like. The component information may include information about an observation method which the microscope component supports as illustrated in FIG. 7, may include information about a dimension of the microscope component as illustrated in FIG. 8, and may include information about a weight of the microscope component as illustrated in FIG. 9.

Thereafter, the processor executes simulation (step S50). In step S50, the processor performs the simulation process illustrated in FIG. 10 based on the plurality of pieces of component information acquired in step S40 to simulate the assembly of the microscope system.

In the simulation process illustrated in FIG. 10, the processor first generates connectivity information (step S51). The connectivity information generated in step S51 is information indicating the success or failure of connection of the combination of the plurality of user components corresponding to the plurality of pieces of component information acquired in step S40. The processor may generate information indicating the success or failure of the combination of all of the plurality of user components (hereinafter, referred to as first connectivity information) as the connectivity information, or may generate information indicating the success or failure of the combination of each of the plurality of user components (hereinafter, referred to as second connectivity information) as the connectivity information. The processor may generate the connectivity information including at least one of the first connectivity information and the second connectivity information.

In step S51, the processor may generate the connectivity information by referring to the connection master information stored in advance in the storage device of the server device 100. The connection master information is information covering the connectivity between the microscope components, and has, for example, a structure like that illustrated in FIG. 11. For example, it can be seen that a frame EE-FFF1 can be connected to both a stage CC-DDD1 and a stage CC-DDD2 by referring to the connection master information. In addition, it can be seen that the frame EE-FFF1 can be connected to a light projecting tube AA-BBB2 but cannot be connected to a light projecting tube AA-BBB1.

The connection master information may cover only connectivity between categories (for example, a frame and a stage) that are likely to be connected, and need not cover connectivity between categories (for example, the stage and the light projecting tube) that are not possible to be connected. Alternatively, information (x) indicating that there is no connectivity may be stored for connectivity between categories (for example, the stage and the light projecting tube) that are not possible to be connected.

Further, the processor generates compatibility information (step S52). The compatibility information generated in step S52 is information indicating compatibility of a combination of a plurality of user components corresponding to the plurality of pieces of component information acquired in step S40 with the user-specified requirement. The processor may generate information indicating compatibility of the combination of the entire plurality of user components with the user-specified requirement (hereinafter, referred to as first compatibility information) as the compatibility information, or may generate information indicating compatibility with the user-specified requirement of each of the plurality of user components (hereinafter, referred to as second compatibility information) as the compatibility information. The processor may generate compatibility information including at least one of the first compatibility information and the second compatibility information.

In step S52, the processor generates compatibility information based on the plurality of pieces of component information acquired in step S40. For example, in a case where the user-specified requirement specifies an observation method to be supported by the microscope system, the compatibility information may be generated using information regarding the observation method supported by the component included in the component information. In a case where the user-specified requirement specifies the allowable dimension of the microscope system, the compatibility information may be generated using the information regarding the dimension of the component included in the component information. In a case where the user-specified requirement specifies the allowable weight of the microscope system, the compatibility information may be generated using the information regarding the weight of the component included in the component information.

Upon completion of the simulation process illustrated in FIG. 10, the processor outputs the simulation result including the generated connectivity information and compatibility information (step S60). In step S60, the simulation result output by the processor is transmitted from the server device 100 to the client device 10. As a result, as illustrated in FIG. 5, the main window 20 is updated, and the simulation result is displayed on the display device of the client device 10.

The simulation result R1 illustrated in FIG. 5 is connectivity information and indicates that the combination of the microscope components displayed in the area 22 can be connected as a whole. In addition, the simulation result R2 illustrated in FIG. 5 is compatibility information and indicates that the combination of the microscope components displayed in the area 22 can support the bright field observation method.

Conventionally, the server device 100 cannot determine the connectivity and compatibility of each component of the microscope unless the combination work of each component of the microscope is actually performed on the actual machine. Therefore, every time a combination determination result indicating that the connectivity or the compatibility is poor occurs, disassembling work of the combined actual machine is required, and there is a problem that the throughput of the combination examination is not good. However, in the above-described embodiment, since the processing of virtualizing the combination work is realized, it is not necessary to perform the disassembling operation of the actual machine accompanying the combination examination, and the throughput of the combination examination by the server device 100 is greatly improved. In addition, by using the connectivity information and the compatibility information which are the simulation results, it is possible to understand the combination of inappropriate components in advance before assembling the actual machine and to save the throughput of the entire process in the sense of eliminating the process of unnecessary actual machine combination.

In this way, by simulating the assembly of the microscope system based on the information input from the client device 10 and outputting the simulation result, the server device 100 can provide the user with information that contributes to the evaluation of the microscope system (whether the microscope components are connectable to each other and the microscope system meets the user-specified requirements) without actually assembling the microscope system. Therefore, according to the server device 100, the user can evaluate the effectiveness of the combination without possessing all the components constituting the combination. In addition, even in a case where the user possesses all the components, since the user can confirm the effectiveness without actually assembling the components, it is possible to avoid repeated assembling and disassembling of the modules (microscope system) and to reduce the labor of work. Furthermore, by avoiding actual assembly, even a user unfamiliar with the microscope system can easily evaluate the microscope system.

In addition, the server device 100 simulates the assembly of the microscope system using the component information indicating the technical specifications of the microscope components, and outputs a simulation result. This makes it possible to provide the user with more information than information such as whether the microscope components are simply connectable. In particular, by using the component information to generate and provide the user with information on the compatibility with the user-specified requirement, the user can easily confirm whether the microscope system meets the requirements.

The server device 100 may have a recommendation function in addition to providing the simulation result to the user. Specifically, the processor may perform the process from step S70 to step S120 illustrated in FIG. 6.

The processor determines whether the connection is successful based on the simulation result (step S70). In a case where the connectivity information generated in step S50 indicates the failure of connection of a combination of a plurality of user components (step S70: NO), the processor outputs information indicating a microscope component (hereinafter, alternative components) substituted for the user component that causes the failure of connection (step S80).

In step S80, the information output by the processor is transmitted from the server device 100 to the client device 10. As a result, as illustrated in FIG. 12, the main window 20 is updated, and a sub-window W that proposes an alternative component is displayed on the display device of the client device 10.

The simulation result R1 illustrated in FIG. 12 indicates that the combination of the user components cannot be connected as a whole, and a simulation result R3 illustrated in FIG. 12 indicates the success or failure of connection for each user component. That is, both the simulation result R1 and the simulation result R3 are the connectivity information, but the simulation result R1 corresponds to the first connectivity information described above, and the simulation result R3 corresponds to the second connectivity information described above.

The sub-window W may be displayed by the user selecting a user component (in this example, a light projecting tube AA-BBB1) for which connection fails. In the sub-window W, the microscope components of the same category that are successfully connected may be listed as alternative components. In addition, as an alternative component, a list of microscope components satisfying the user-specified requirement may be displayed from among microscope components of the same category that are successfully connected.

In this manner, the server device 100 provides the user with the information that can identify the microscope component that causes the failure of the connection, so that the user can find the combination of connectable microscope components only by changing the microscope component that causes the failure to another microscope component. In addition, since the server device 100 proposes an alternative component, it is possible to reduce the burden on the user due to the reconsideration of the combination.

Here, an example of proposing a component that substitutes for the microscope component that has caused the failure of the connection has been described. However, the server device 100 may propose a microscope component of a category in which the microscope component is not specified by the user. Even in this case, it is possible to propose a microscope system that meets the user's requirement by considering connectivity and compatibility.

Further, the processor determines whether or not to meet the user-specified requirement based on the simulation result (step S90). If the compatibility information generated in step S50 indicates the non-compatibility with the user-specified requirement (step S90: NO), the processor outputs information indicating an alternative component to be substituted for the microscope component that causes the non-compatibility (step S100).

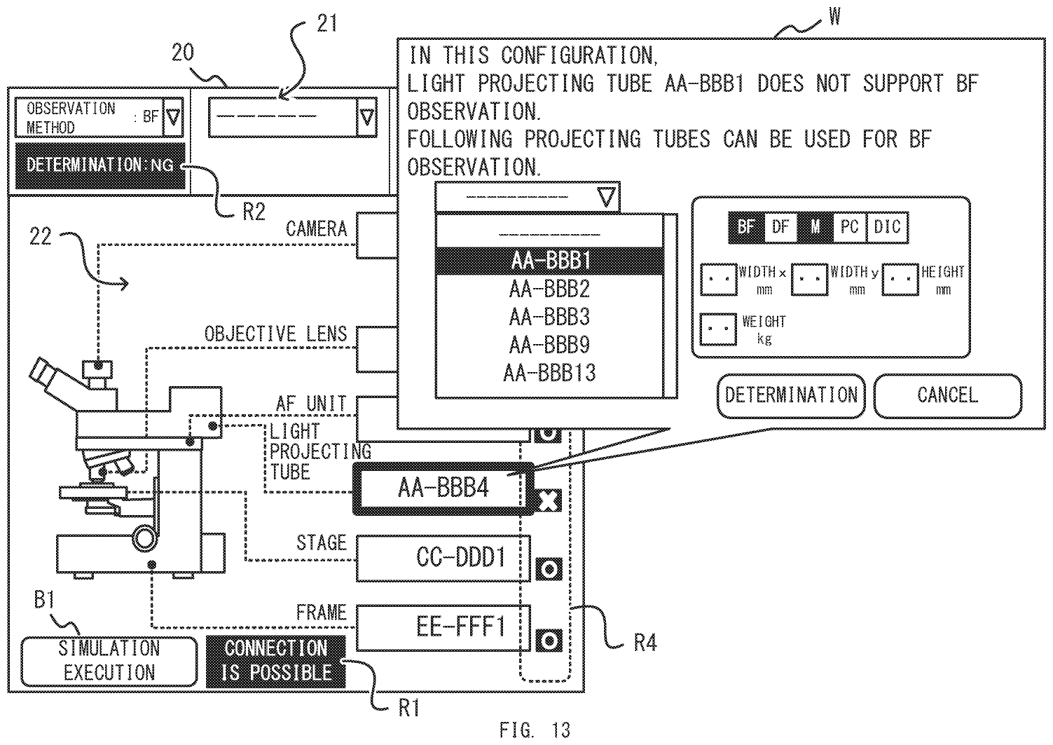

In step 5100, the information output by the processor is transmitted from the server device 100 to the client device 10. As a result, as illustrated in FIG. 13, the main window 20 is updated, and a sub-window W that proposes an alternative component is displayed on the display device of the client device 10.

The simulation result R2 illustrated in FIG. 13 indicates that the combination of the microscope components as a whole is non-compatible with the user-specified requirement, and the simulation result R4 illustrated in FIG. 13 indicates compatibility/incompatibility with the user-specified requirement for each individual user component. That is, both the simulation result R2 and the simulation result R4 are the compatibility information, but the simulation result R2 corresponds to the first compatibility information described above, and the simulation result R4 corresponds to the second compatibility information described above.

The sub-window W may be displayed by the user selecting a non-compatible user component (in this example, a light projecting tube AA-BBB4). As an alternative component, the sub-window W may display the microscope components of the same category that meet user-specified requirements in a list. In addition, as the alternative component, a list of the microscope components that are successfully connected may be displayed among microscope components of the same category that meet the user-specified requirement.

In this manner, the server device 100 provides the user with information that can identify the microscope component that does not meet the user-specified requirement, so that the user can find the combination of the microscope components that meets the user-specified requirement only by changing the non-matching microscope component to another microscope component. In addition, since the server device 100 proposes an alternative component, it is possible to reduce the burden on the user due to the reconsideration of the combination.

The proposal of the alternative component may be performed using, for example, template information in which a requirement to be satisfied by the microscope system is associated with a combination (recommended combination) of microscope components meeting the requirement as illustrated in FIG. 14. The template information may be stored in, for example, the storage device of the server device 100. In step S100, the processor may acquire the recommended combination from the template information corresponding to the user-specified requirement, and identify the microscope component to be substituted for the microscope component causing the non-compatibility from the acquired recommended combination. It is desirable that the processor acquire a recommended combination including the simulated combination (however, the microscope components that cause non-compatibility are excluded) from the template information corresponding to the user-specified requirement, and identify a microscope component to be substituted for the microscope component causing the non-compatibility from the acquired recommended combination. This makes it possible to take full advantage of the selection of the microscope component by the user.

Here, an example of proposing a component that substitutes for the microscope component causing the non-compatibility has been described. However, the server device 100 may propose a microscope component of a category in which the microscope component is not specified by the user. Even in this case, it is possible to propose a microscope system that meets the user's requirement by considering connectivity and compatibility.

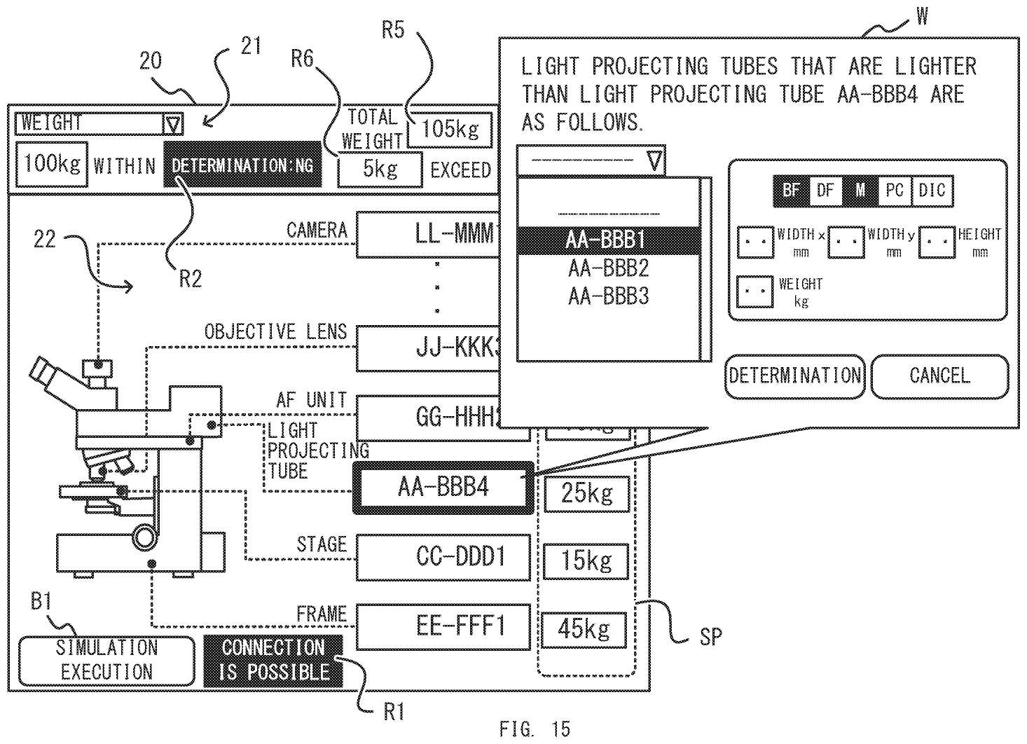

FIG. 13 illustrates an example in which the bright field observation method is specified as the observation method to be supported by the microscope system, but the user-specified requirement is not limited to that related to the observation method. As shown in FIG. 15, the allowable weight for the microscope system (100 kg) may be specified.

The simulation result R2 illustrated in FIG. 15 indicates that the combination of the microscope components as a whole is non-compatibility with the user-specified requirement. A simulation result R5 illustrated in FIG. 15 indicates the total weight (105 kg) of the microscope system obtained by adding up the weights of the respective microscope components. A simulation result R6 illustrated in FIG. 15 indicates the difference (more than 5 kg) between the total weight and the allowable weight of the microscope system. The simulation result R2 and the simulation result R6 directly indicate the compatibility with the user-specified requirement, whereas the simulation result R5 indirectly indicates the compatibility with the user-specified requirement. However, the simulation result R2, the simulation result R5, and the simulation result R6 are all compatibility information, and all correspond to the first compatibility information described above. In addition, as illustrated in FIG. 15, the weight (a specification information SP) of each microscope component may be displayed.

Further, the processor determines the presence or absence of limitations in use in the combination of the simulation targets (step S110). Limitations in use may be, for example, specific conditions under which the microscope component does not perform its original function. This specific condition may be stored in the storage device, for example, as component information of a microscope component (referred to as a use-limiting component) that does not perform its original function. Specifically, it may be stored as a specific setting in a specific combination of the use-limiting component and other microscope components. For example, in a case where a certain autofocus device does not function when a filter block is used in combination with a certain light projecting tube, information regarding these limitations may be stored as component information of the autofocus device. Therefore, the processor may determine the presence or absence of the limitations based on the component information. In addition, the processor may determine the presence or absence of the limitation on the basis of information regarding the limitations managed separately from the component information. For example, information regarding the limitations in use may be stored for each observation method, and when a combination which a specific observation method supports is simulated, the presence or absence of the limitations in use may be determined on the basis of the information regarding the limitation on specification stored for each observation method.

When determining that there is a limitation in use in step S110 (step S 110: YES), the processor outputs information indicating the limitation in use in the combination of the plurality of microscope components (step S120).

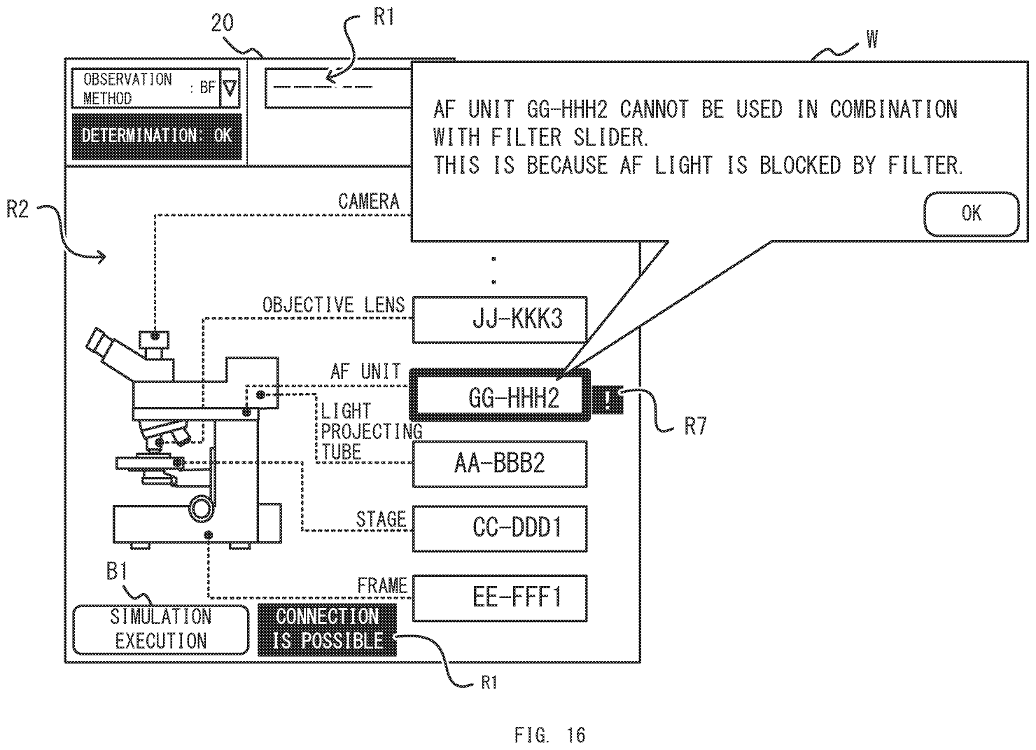

In step S120, the information output by the processor is transmitted from the server device 100 to the client device 10. As a result, as illustrated in FIG. 16, the main window 20 is updated, and the sub-window W for calling attention to the limitations in use is displayed on the display device of the client device 10.

A simulation result R7 illustrated in FIG. 16 indicates that there are limitations in use of an AF unit GG-HHH2. Note that the sub-window W may be displayed by the user selecting a user component (in this example, the AF unit GG-HHH2) having the limitations in use.

As described above, the server device 100 provides the user with the information regarding the limitations in use separately from the connectivity and compatibility, and thus, even in a case where there is an inconvenience that occurs under a specific condition although it is not always an inconvenience that occurs when the microscope components are combined, it is possible to call the user's attention to the details.

As described above, the server device 100 performs the process illustrated in FIG. 6, so that the information contributing to the evaluation of the microscope system can be provided to the user without actually assembling the microscope system. Therefore, a manufacturer that manufactures and sells a microscope and a microscope component can urge a potential customer to make a specific consideration, and can promote product sales.

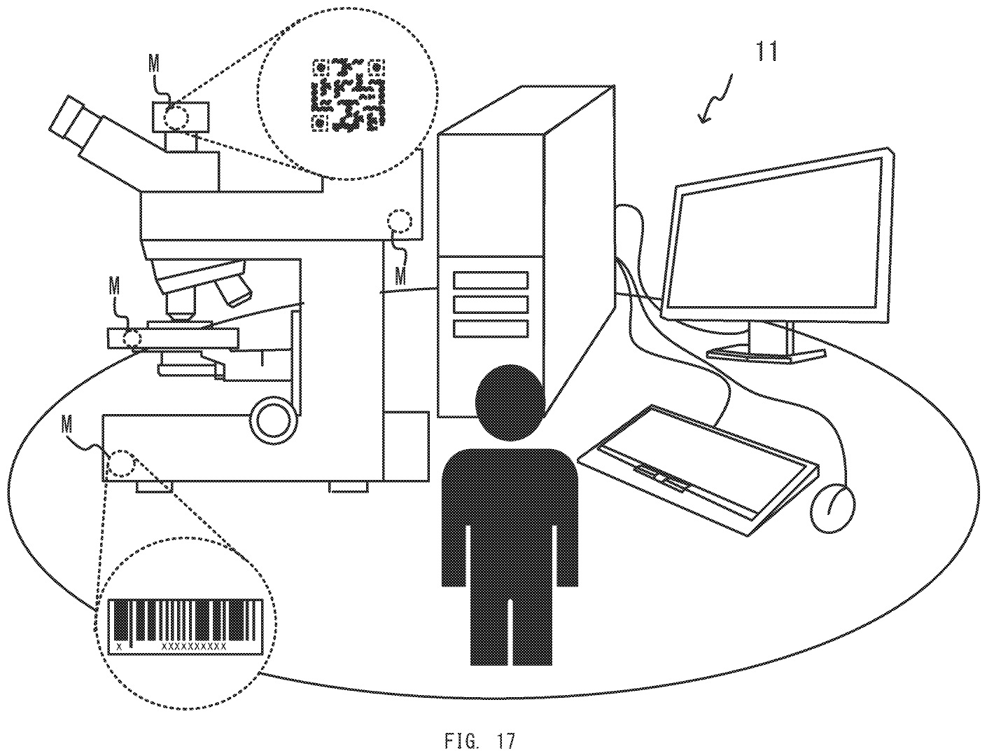

Note that, in the above, an example has been described in which the microscope components constituting the combination of the simulation targets are specified on the application, but the method of specifying the microscope components is not limited to this example. For example, as illustrated in FIG. 17, identification information M of the microscope component incorporated in the actual microscope system may be read to specify the microscope component constituting the combination of the simulation targets. The identification information M may be, for example, a one-dimensional or two-dimensional code represented by a barcode or a QR code (registered trademark). As a result, the combination of the microscope systems of the user can be easily incorporated into the application. The identification information M may be associated with information such as a manufacturing year, a serial number, a purchase date, and a service life of the microscope component (here, the specific individual of the microscope component) stored as master data. Specifically, it is possible to display the service life (including the remaining life) or like of the microscope component actually used by the user by reading the identification information M of the specific microscope component. If the remaining useful life is short, a notification of replacement time or the like may be displayed. Therefore, it is possible to easily simulate addition, change, deletion, and the like of a new microscope component to the microscope system of the user and promote sales.

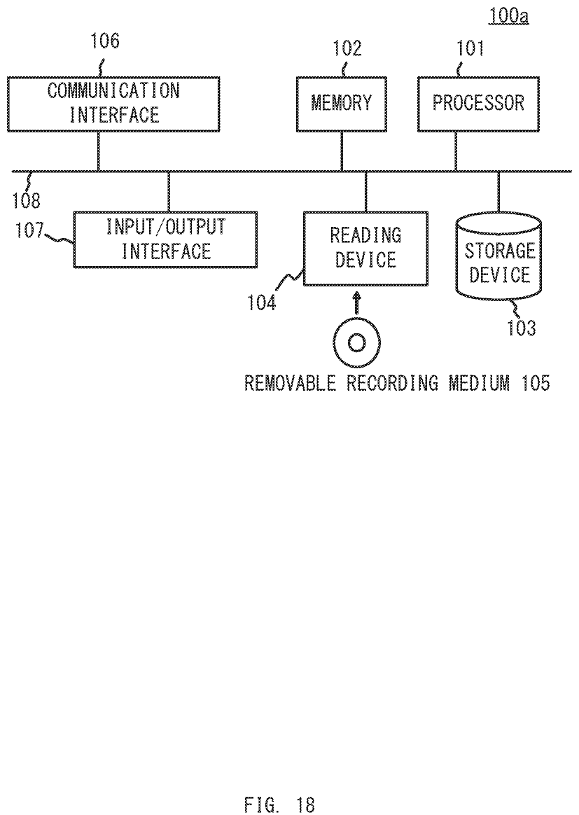

FIG. 18 is a diagram illustrating an example of a hardware configuration of a computer 100a to achieve the server device 100 according to the above-described embodiment. The hardware configuration illustrated in FIG. 18, for example, includes a processor 101, a memory 102, a storage device 103, a reading device 104, a communication interface 106, and an input/output interface 107. Note that the processor 101, the memory 102, the storage device 103, the reading device 104, the communication interface 106, and the input/output interface 107 are connected to one another, for example, via a bus 108.

For example, the processor 101 may be a single processor, a multiprocessor, or a multicore processor. The processor 101 reads and executes a program stored in storage device 103 and thereby operates as the detection unit 110, the acquisition unit 120, the simulation unit 130, and the output unit 140 described above.

For example, the memory 102 is a semiconductor memory, and may include a RAM area and a ROM area. For example, the storage device 103 is a hard disk, a semiconductor memory such as a flash memory, or an external storage device.

For example, the reading device 104 accesses a removable recording medium 105 in accordance with an instruction of the processor 101. For example, the removable recording medium 105 is achieved by a semiconductor device, a medium to/from which information is input/output by a magnetic action, a medium to/from which information is input/output by an optical action. Note that, for example, the semiconductor device is a universal serial bus (USB) memory. Further, the medium from/to which information is input/output by the magnetic action is, for example, a magnetic disk. The medium from/to which information is input/output by the optical action is, for example, a compact disc (CD)-ROM, a digital versatile disk (DVD), or a Blu-ray disc (Blu-ray is a registered trademark).

The communication interface 106 communicates with other devices, for example, in accordance with the instruction of the processor 101. The input/output interface 107 is an interface, for example, between an input device and an output device. The input device is, for example, a device which receives an instruction from the user such as a keyboard, a mouse, or a touch panel. The output device is, for example, a display device such as a display or a sound device such as a speaker. The detection unit 110 and the acquisition unit 120 described above may include the input/output interface 107. Furthermore, the output unit 140 described above may include at least one of the communication interface 106 or the input/output interface 107.

The program to be executed by the processor 101 is provided to the computer 100a, for example, in the following forms.

(1) Installed in the storage device 103 in advance

(2) Provided by the removable recording medium 105

(3) Provided from a server such as a program server

Note that the hardware configuration of the computer 100a for achieving the server device 100 described with reference to FIG. 18 is merely an example, and the embodiment is not limited thereto. For example, the above-mentioned configuration may be partially deleted, or a new constituent may be added thereto. Moreover, in another embodiment, for example, a part or all of the functions of the above-mentioned electric circuit may be implemented as hardware by a field programmable gate array (FPGA), a system-on-a-chip (SoC), an application specific integrated circuit (ASIC), a programmable logic device (PLD), and the like.

The above embodiments are specific examples for facilitating the understanding of the invention, and the present invention is not limited to these embodiments. Modifications obtained by modifying the above embodiments and alternative forms replacing the above embodiments can be included. That is, in each embodiment, the constituent elements can be modified without departing from the spirit and the scope thereof. Further, a new embodiment can be implemented by appropriately combining the multiple constituent elements disclosed in one or more of the embodiments. Further, some constituent elements may be omitted from the constituent elements described in the corresponding embodiment, or some constituent elements may be added to the constituent elements described in the embodiment. Further, the order of the process procedures in each embodiment is interchangeable as long as there is no contradiction. That is, the device, the method, and the program of the present invention can be variously modified and changed without departing from the scope of the invention defined by the claims.

In the embodiment described above, the connectivity information and the compatibility information are generated in the simulation processing, but it is not always necessary to generate both. For example, the server device 100 may generate and output only the compatibility information.

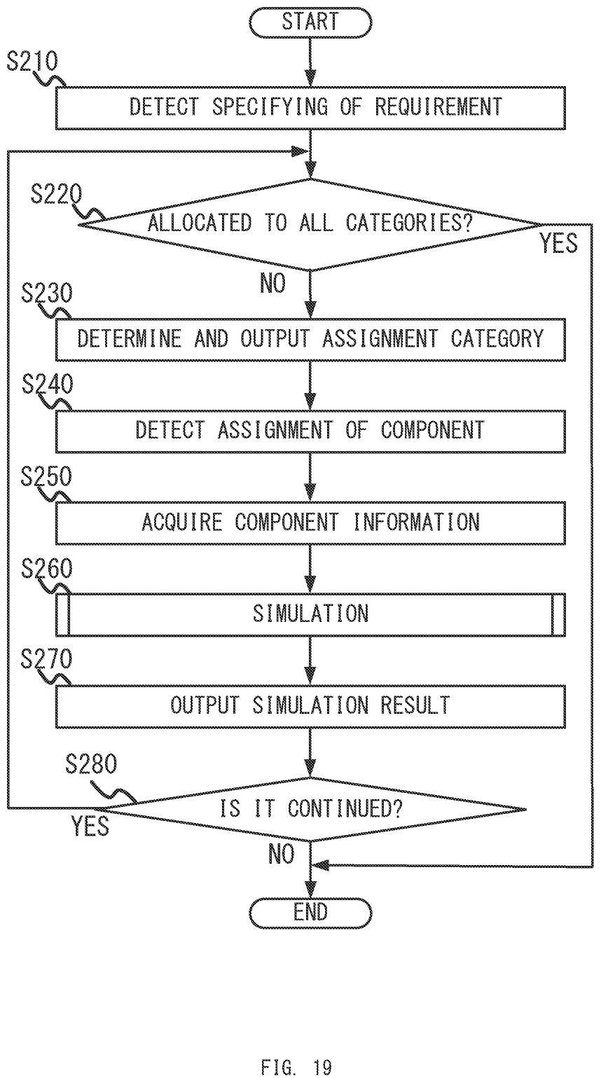

Although not specifically mentioned in the above-described embodiment, it is desirable that the simulation assembly procedure of each component be performed and displayed in the order of actually assembling the microscope. Specifically, restrictions on the actual machine such as combining the frame and the stage first and combining the objective lens last may be reflected in the simulation. As a result, in a case where the user sequentially considers the combination of the components in order, it is possible to perform the simulation with a sense closer to an actual microscope assembly sense. For example, as illustrated in FIG. 19, after detecting the specifying of the requirement (step S210), the server device 100 may determine whether the microscope components have been allocated to all the categories (step S220), determine a category to which the microscope component is to be assigned when there is a category for which the assignment has not been completed (step 5220: NO), and output category information prompting the allocation of the microscope component to the category to the client device (step S230). The category information output in step 5230 may be output according to the order of the predetermined categories, specifically, the actual assembly order of the microscope. Since the user assigns the microscope component to each category according to the category information output in a specific order, the server device 100 can perform simulation reflecting an actual assembly procedure. Furthermore, thereafter, when the server device 100 detects the assignment of the microscope component, a series of processes (steps S240 to S270) such as acquisition of component information, simulation, and output of a result may be performed, and thus simulation may be performed and a result thereof may be displayed each time the microscope component is assigned. The server device 100 may simulate the assembly of the entire microscope system by repeating the processing as much as the user desires to continue the simulation (step S280: YES).

Although not particularly mentioned in the embodiment described above, the server device 100 may distinguish the client device 10 and the user and manage the use history of the application for each of the client device 10 and the user. The recommendation function may be personalized using the use history. For example, a microscope component frequently selected by the user may be stored, and an upward compatible product or the like of the component may be recommended. In addition to the use history of the user, the recommendation function may be extended using the use history of another user having a similar use history. Accordingly, it is possible to more easily promote the sales to the user.

In the above-described embodiment, an example has been described in which the microscope component to be simulated is specified after specifying the requirements to be satisfied by the microscope system, but the user may specify the microscope component without specifying the requirements to be satisfied by the microscope system. By displaying the component information of each microscope component in a list as illustrated in the area 23, the user himself/herself may voluntarily select a microscope component that satisfies the requirement.

In the above-described embodiment, the example in which the simulation is performed after the microscope component to be simulated is specified has been described. However, the server device 100 may propose a combination of the microscope components based on only the specified requirements to be satisfied by the microscope system without accepting the designation of the microscope component to be simulated. This combination of microscope components may be selected from the recommended combinations described above. In addition, a combination of a plurality of microscope components may be proposed, and the proposed combination of the microscope components may be narrowed down by the user adding a requirement. Note that the server device 100 may accept designation of only one microscope component to be simulated and propose a combination of microscope components on the basis of the specified requirement that the microscope system should satisfy and the one microscope component.

In the above-described embodiment, the example in which the simulation is performed by designating the microscope component to be simulated has been described. However, the simulation may be performed by designating the microscope component (that is, the type of microscope component) to be simulated and further designating detailed information (that is, the individual of the microscope component) of the microscope component. The detailed information is information for each individual, unlike, for example, specifications common to the microscope components. The detailed information may be, for example, information on the purchase date of the microscope component, or may be information on the years of use or the frequency of use of the microscope component. The detailed information may be managed for each individual by the server device 100 as part of the master data of the microscope component. Further, the detailed information such as the years of use and the frequency of use may be read out at necessary timing from a sensor attached to the microscope component that is actually used. Further, these pieces of detailed information may be stored in the client device 11 (the microscope system) including the microscope component. In addition to the simulation described above, the server device 100 may suggest the user to replace the component by using the detailed information. Furthermore, in addition to the detailed information, for example, the server device 100 may predict the release date of a new product of the component using the information on the release date of the microscope component stored as the component information and suggest the user to replace the component with the new product.

In the above-described embodiment, an example in which the connectivity information and the compatibility information are generated by the simulation processing has been described, but an image captured by the microscope system as the simulation target may be reproduced. The user can further examine in detail whether the microscope system satisfies his/her requirements by the reproduced image. Note that the reproduced image may be generated by processing an original image prepared in advance, and the original image may be provided by the user.

In the above-described embodiment, an example in which the total weight and the total height of the microscope are specified as the requirements has been described, but the requirements are not limited thereto. For example, if the price of each component is stored in the master data, the total price of the microscope may be specified and displayed as the requirement. The connectivity information and the compatibility information relating the technical specification of the microscope component are more important in that introduction of the component becomes impossible when the simulation result is negative. In addition to these pieces of information, price information that is not a technical specification of the microscope component is displayed, so that the user can more conveniently consider addition and change of each component.

In the above-described embodiment, an example in which the client device 10 and the server device 100 are separate devices connected via the network has been described. However, the client device 10 and the server device 100 may be the same device. For example, a computer of the microscope system may function as the server device 100. The server device 100 may be a cloud server that can be accessed by a client terminal via the Internet, and may be, for example, a virtual device including a set of one or more computers.

In the above-described embodiment, an example in which simulation is performed by the server device 100 has been described, but the device that executes simulation is not limited to the server device 100. For example, the simulation may be performed in the client device using the master data stored in the server device 100. In particular, in a case where simulation is performed in the client device 11 which is a microscope system, information of the microscope component incorporated in the microscope included in the client device 11 may be acquired, and the microscope component may be automatically assigned to each category based on the information. As a result, the user can easily consider introduction of a new microscope component to the client device 11 only by partially changing or adding the assignment of the microscope component to the category.

What is claimed is:

1. A microscope simulation device comprising:
a processor, wherein
the processor is configured to perform
acquiring a plurality of pieces of component information each indicating a technical specification of a corresponding microscope component,
simulating an assembly of a microscope system based on the acquired plurality of pieces of component information, and
outputting a generated simulation result to a display device.

2. The microscope simulation device according to claim 1, wherein
the processor is further configured to perform detecting a user's operation of assigning a microscope component to a category that classifies the microscope component, and
the acquiring of the plurality of pieces of component information includes acquiring component information of a user component that is a microscope component assigned to the category by a detected operation.

3. The microscope simulation device according to claim 2, wherein
the simulating the assembly of the microscope system includes determining success or failure of a connection of a combination of a plurality of microscope components corresponding to the plurality of pieces of component information, and
the outputting the simulation result to the display device includes outputting connectivity information that is generated by determining success or failure of the connection and indicates success or failure of the connection of the combination of the plurality of microscope components as at least a part of the simulation result.

4. The microscope simulation device according to claim 3, wherein the connectivity information includes at least one of:
first connectivity information indicating success or failure of a combination of all of the plurality of microscope components; and
second connectivity information indicating success or failure of each combination of the plurality of microscope components.

5. The microscope simulation device according to claim 4, wherein
the simulating the assembly of the microscope system further includes, in a case where the connectivity information indicates a failure in connecting the combination of the plurality of microscope components, determining a connection candidate component that is a microscope component that replaces a microscope component that causes the failure, and
the outputting the simulation result to the display device includes outputting alternative candidate information indicating the connection candidate component generated by determining the connection candidate component.

6. The microscope simulation device according to claim 2, wherein
the processor is further configured to perform detecting a user's operation specifying a requirement to be satisfied by the microscope system,
the acquiring the plurality of pieces of component information includes acquiring a user-specified requirement that is a requirement specified by the operation specifying a requirement to be satisfied by the microscope system,
the simulating the assembly of the microscope system further includes determining compatibility of a combination of the plurality of microscope components with the user-specified requirements, and
the outputting the simulation result to the display device includes outputting compatibility information indicating the compatibility of the combination of the plurality of microscope components with the user-specified requirement as at least a part of the simulation result, the compatibility information being generated by the determining compatibility with the user-specified requirement.

7. The microscope simulation device according to claim 6, wherein the compatibility information includes at least one of:
first compatibility information indicating compatibility of the combination of all of the plurality of microscope components with the user-specified requirement; and
second compatibility information indicating compatibility with the user-specified requirement of each of the plurality of microscope components.

8. The microscope simulation device according to claim 7, wherein
the simulating the assembly of the microscope system further includes, in a case where the compatibility information indicates non-compatibility with the user-specified requirement, determining a compatibility candidate component, which is a microscope component that replaces the microscope component that causes the non-compatibility, and
outputting the simulation result to the display device includes outputting alternative candidate information indicating the compatibility candidate component generated by determining the compatibility candidate component.

9. The microscope simulation device according to claim 8, wherein
the determining the compatibility candidate component includes
acquiring, from template information associating a requirement to be satisfied by the microscope system and a combination of microscope components meeting the requirement, a recommended combination that is a combination of microscope components meeting the user-specified requirement, and
specifying the compatibility candidate component based on the recommended combination.

10. The microscope simulation device according to claim 1, wherein
the processor is further configured to perform detecting a user's operation of specifying a requirement to be satisfied by the microscope system,
the acquiring the plurality of pieces of component information includes acquiring a user-specified requirement that is a requirement specified by the operation specifying a requirement to be satisfied by the microscope system,
the simulating the assembly of the microscope system includes acquiring, from template information associating a requirement to be satisfied by the microscope system and a combination of microscope components meeting the requirement, a recommended combination that is a combination of microscope components meeting the user-specified requirement, and
the outputting the simulation result to the display device includes outputting information indicating the recommended combination as at least a part of the simulation result.

11. The microscope simulation device according to claim 6, wherein the requirement to be satisfied by the microscope system includes at least one of:
an observation method to be supported by the microscope system;
an allowable dimension of the microscope system; and
an allowable weight of the microscope system.

12. The microscope simulation device according to claim 7, wherein the requirement to be satisfied by the microscope system includes at least one of:
an observation method to be supported by the microscope system;
an allowable dimension of the microscope system; and
an allowable weight of the microscope system.

13. The microscope simulation device according to claim 8, wherein the requirement to be satisfied by the microscope system includes at least one of:
an observation method to be supported by the microscope system;
an allowable dimension of the microscope system; and
an allowable weight of the microscope system.

14. The microscope simulation device according to claim 9, wherein the requirement to be satisfied by the microscope system includes at least one of:
an observation method to be supported by the microscope system;
an allowable dimension of the microscope system; and
an allowable weight of the microscope system.

15. The microscope simulation device according to claim 10, wherein the requirement to be satisfied by the microscope system includes at least one of:
an observation method to be supported by the microscope system;
an allowable dimension of the microscope system; and
an allowable weight of the microscope system.

16. The microscope simulation device according to claim 2, wherein
the outputting the simulation result to the display device includes outputting category information prompting assignment of a microscope component to a specific category according to an order of a predetermined category, and
the simulating the assembly of the microscope system includes simulating the assembly of the microscope system each time the operation of assigning microscope components to a category for classifying the microscope components is detected.

17. The microscope simulation device according to claim 1, wherein
the simulating the assembly of the microscope system further includes determining limitations in use in a combination of a plurality of microscope components corresponding to the plurality of pieces of component information, and
the outputting the simulation result to the display device includes outputting limitation information indicating limitations in use in a combination of the plurality of microscope components.

18. The microscope simulation device according to claim 1, wherein the component information of the microscope component includes at least one of:
information on an observation method which the microscope component supports,
information on a dimension of the microscope component, and
information on a weight of the microscope component.

19. A computer-implemented method, comprising:
acquiring a plurality of pieces of component information each indicating a technical specification of a corresponding microscope component;
simulating an assembly of a microscope system based on the plurality of pieces of component information; and
outputting a simulation result of the assembly of the microscope system to a display device.

20. A non-transitory computer readable medium that stores a program for causing a computer to execute processes of:
acquiring a plurality of pieces of component information each indicating a technical specification of a corresponding microscope component;
simulating an assembly of a microscope system based on the plurality of pieces of component information; and
outputting a simulation result of the assembly of the microscope system to a display device.
